(19) United States
(12) Patent Application Publication
(10) Pub. No.: US 2014/0183855 A1
(43) Pub. Date: Jul. 3, 2014

(54) METHOD FOR PRODUCTION OF AN IRIDESCENT IMAGE, THE RESULTING IMAGE, DEVICE COMPRISING SAME AND ASSOCIATED PROGRAM

(71) Applicant: Christophe Lanfranchi, La Frette Sur Seine (FR)

(72) Inventor: Christophe Lanfranchi, La Frette Sur Seine (FR)

(21) Appl. No.: 14/115,243

(22) PCT Filed: Jun. 12, 2012
(86) PCT No.: PCT/FR2012/051313

§ 371 Date: Feb. 20, 2014

(30) Foreign Application Priority Data
May 3, 2011 (FR) 1153752

(51) Int. Cl. B42D 15/00; G06T 3/40

(52) U.S. Cl. CPC B42D 15/0013; G06T 3/40
USPC 283/85; 382/298; 382/162

(57) ABSTRACT

Method for the production of an iridescent image (II) from a reference image (IR) is described. The iridescent image (II) comprises an optical selector (SO) selected from an array of cylindrical lenses, an array of spherical lenses and a parallax barrier. The method includes creating a period adapted to the optical selector (SO) and to the reproduction system used; creating a periodic image (IP) filled in a repetitive manner according to said period; creating a dispersed image by applying a dispersion filter to the periodic image (IP), in which the geometric position of the pixels of the periodic image (IP) is modified as function of the values of the corresponding pixels in the reference image (IR); and associating the created dispersed image (ID) with the optical selector (SO). The invention also relates to the iridescent dispersed images obtained using the method, a device comprising said images and an associated program.

### TECHNICAL FIELD OF THE INVENTION

The invention relates to the field of the creation of iridescent images. The iridescence effect occurs when our eyes, distant from each other, perceive, from the same object, different colours and/or light intensities. Such images are for example used for producing a more aesthetic display on packages of products. Effects that are eye-catching and prominent for the consumer thus result from this.

An image of this type may also be provided on a bank or telephone card, a shop window, a decoration, a press dossier, a greetings card, a garment or footwear marking, or a communication element such as a commercial card.

### PRIOR ART

Numerous methods for creating images with an iridescent effect have been proposed. Thus, through the document EP 1 147 878, a moiré or iridescent pattern produced from a matrix of lenticular elements printed on at least one surface of a substrate is known. This device does not however prove to be fully satisfactory. This is because this document does not make it possible to produce an iridescent image easily from a given reference image such as a drawing, a photograph or a text.

### DISCLOSURE OF THE INVENTION

The invention aims to remedy the drawbacks of the prior art mentioned above.

To do this, a method for producing an iridescent image from a reference image is proposed, where the iridescent image comprises an optical selector chosen from the group comprising an array of cylindrical lenses, an array of spherical lenses and a parallax barrier.

According to a first aspect of the invention, the method comprises the steps of
creating a period adapted to the optical selector and to the reproduction system used,
creating a periodic image filled in a repetitive manner according to said period,
creating a dispersed image by applying a dispersion filter (displacement mapping) to the periodic image, in which the geometric position of the pixels of the periodic image is modified according to the values of the corresponding pixels in the reference image,
associating the dispersed image thus created with the optical selector.

Period adapted to an optical selector means a succession of repeated elements such as pixels of an image, the repetition of which corresponds to said optical selector used. Period adapted to an image production system means a period the resolution and number of colours of which can be reproduced by said given image production system.

“Periodic image” means an image comprising a succession of elements repeated according to a given period. These repeated elements give their colours to the iridescence effects in the iridescent image obtained.

“Reference image” means an image that represents, to within the colours, what is perceived of the iridescent image. The reference image may represent for example a drawing, a photograph or a text.

“Optical selector” means an element associated with the dispersed image so as to enable the observer to perceive the iridescence effects. Such an optical selector is for example an array of linear lenses, also referred to as a lenticular array, which comprises longitudinal cylindrical lenses. Such an optical selector may also be an array of spherical lenses or a parallax barrier. In general terms, a parallax barrier comprises lines, circles, ellipses, squares, diamonds, zigzags, etc., the size and frequency of which are preferably fixed, and which may be printed, etched, moulded, sandblasted or deposited hot or in a transparent or translucent substrate, for example made from PVC, glass, Plexiglas® (polymethyl methacrylate), thus exhibiting a periodic structure of transparent, translucent or opaque areas. The optical selector may also comprise reserve (mask) areas if it is wished for the iridescent image not to exhibit an iridescence effect over all of it.

Concerning the reproduction of the dispersed image, it is necessary to adapt the size of said dispersed image precisely according to the optical selector used and the mean observation distance defined according to the application envisaged. This is done according to the well-known prior art (adjustment of the pitch) by associating a nomogram with the optical selector under the same conditions as the final association. The nomogram consists of a periodic image with a basic period, black pixels white pixels, and contains areas with various size modifications. The one that is suitable is the one that allows a very rapid change from black to white when the observer is placed at the average distance defined and moves slightly perpendicular to the lenses.

“Formation” of an image means producing this image preferably by computer means.

The association of the dispersed image with the optical selector in order to obtain the iridescent image may consist of a reproduction of the dispersed image preferably formed on the face of the optical selector opposite to the observer, or a lamination on this face while providing a necessary space between the optical selector and the dispersed image for reasons of focus explained below. The dispersed image formed may also be reproduced on a face of the optical selector by etching, moulding, sandblasting or any other method allowing such reproduction. Thus the association consists for example of a reproduction such as gravure printing, moulding or sandblasting. In the case of an etching in a block of glass, the dispersed image is etched behind the parallax barrier itself etched, leaving a focal distance that is detailed below between the two.

According to a preferred variant, the method also comprises a step of applying a fuzziness to all or part of the reference image, before the step of applying said dispersion filter.

According to another preferred variant, the step of creating the periodic image and/or the step of creating the dispersed image is performed by means of at least one mask covering at least part of the periodic image and/or of the dispersed image and/or of the optical selector.

In general terms the colour mode of the period is adapted to the reproduction system used and may represent either a single layer of colour, in bitmap or in grey level, or three red green blue layers, or four cyan magenta yellow black layers. Advantageously, the period comprises either a single layer of colour, in bitmap or in grey level, or two layers of colours, the lightest of which is a constant value over the whole of said period.

In the case of a formation of a dispersed image comprising vectorial data, for example for laser etching in a glass block, the method described previously in bitmap mode may also be adapted in vectorial mode by applying the dispersion filter to the vectors of the image instead of the pixels of the image, or by vectorising the dispersed image.

Preferentially, the modification of the position of the pixels has a maximum amplitude of between half and twice the size of a period. A greater amplitude creates a great deal of aliasing and may also be interesting for aesthetic purposes.

Interestingly, the size of the periodic image and that of the reference image are proportional.

Advantageously, the colour mode of the periodic image represents either a single layer in grey level, or three red green blue layers.

According to a preferred embodiment, the resolution of the reference image is less than or equal to the resolution of the periodic image.

According to a preferred variant of the method according to the invention, the optical selector is selected from the group comprising an array of linear lenses and a parallax barrier consisting of lines, and the dispersion function is applied on an axis substantially perpendicular to the linear lenses or to the lines.

According to another preferred variant, the optical selector is a parallax barrier, and a second dispersed image is created from the reference image by applying a second dispersion filter to a periodic image adapted to said parallax barrier, and the step of associating the two dispersed images in order to create the iridescent image comprises a reproduction of said dispersed images on either side of or in a transparent or translucent substrate so that the parallax barrier consists of one of the two dispersed images in combination with the transparent or translucent substrate.

The invention also relates to a dispersed image obtained from a reference image and intended to be observed through an optical selector, characterised in that the dispersed image is formed by position pixels modified by an application of a dispersion filter in which the geometric position of the pixels of a periodic image of determined period is modified according to the values of the corresponding pixels in the reference image.

Another subject matter of the invention consists of an iridescent image comprising the dispersed image described previously, associated with an optical selector selected from the group comprising an array of linear lenses, an array of spherical lenses and a parallax barrier.

The dispersed image and the iridescent image according to the invention are preferably obtained by the method described previously.

Advantageously, the modification of the position of the pixels has an amplitude of between half and twice the size of a period. A greater amplitude creates a great deal of aliasing and may also be interesting for aesthetic purposes.

Another subject matter of the invention consists of a device characterised in that it comprises a dispersed image as described previously or obtained by the method described previously, associated with an optical selector selected from the group comprising an array of linear lenses, an array of spherical lenses and a parallax barrier.

Such a device may, non-limitatively, be a bank or telephone card, a shop window, a package, a decoration, a garment or footwear marking, a ruler, a key fob, a flask, a bottle, a plate, a glass, a vase, a shade, a box, an etched glass block, a communication element such as a commercial card, a press dossier, a booklet, a sign, an industrial marking, a publishing product such as a poster, a postcard, a greetings card, a bookmark, a file cover, a book, a notebook or copy book, an item of jewelry such as a bracelet, a pendant, a brooch or the face of a watch or clock, a tile or glazing.

Another subject matter of the invention consists of a secret image comprising a dispersed image as described previously, or obtained by the method described previously, intended for one or more given observers, characterised in that the period and/or the optical selector (SO) adapted are known to and/or held exclusively by said one or more given observers so as to be able to recreate the corresponding iridescent image.

Another subject matter of the invention consists of an anti-counterfeit security image comprising a dispersed image as described previously or obtained by the method described previously, or an iridescent image as described previously or obtained by the method described previously.

Another subject matter of the invention consists of a computer program product able to be loaded into the memory of a control unit such as computer, comprising means for implementing the method described previously.

### BRIEF DESCRIPTION OF THE FIGURES

Other features, details and advantages of the invention will emerge from a reading of the following description, with reference to the accompanying figures, which illustrate:

FIG. 1A, a periodic image for creating an iridescent image according to the invention;

FIG. 1B, the period of the image in FIG. 1A, consisting of five black pixels and five white pixels;

FIG. 2, a reference image;

FIG. 3, a dispersed image that is the result of the dispersion filter applied to the periodic image in FIG. 1A according to the reference image in FIG. 2;

FIG. 4, an iridescent image comprising the dispersed image in FIG. 3 associated with an array of linear lenses, and observed at different successive angles A1 to A6 and covering the whole of the field angle of the optical selector;

FIG. 5, a diagram of a view in perspective of a dispersed image associated with an array of linear lenses;

FIG. 6, a diagram of the dispersed image and of the array of linear lenses in FIG. 5 in front view.

For more clarity, the identical or similar elements are marked by identical reference signs in all the figures.

### DETAILED DESCRIPTION OF EMBODIMENTS

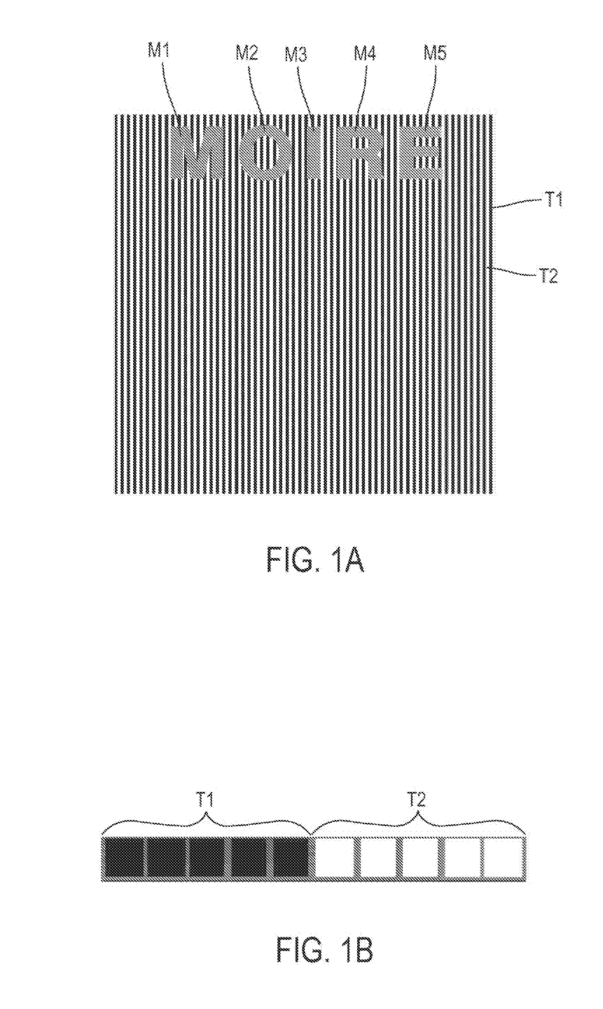

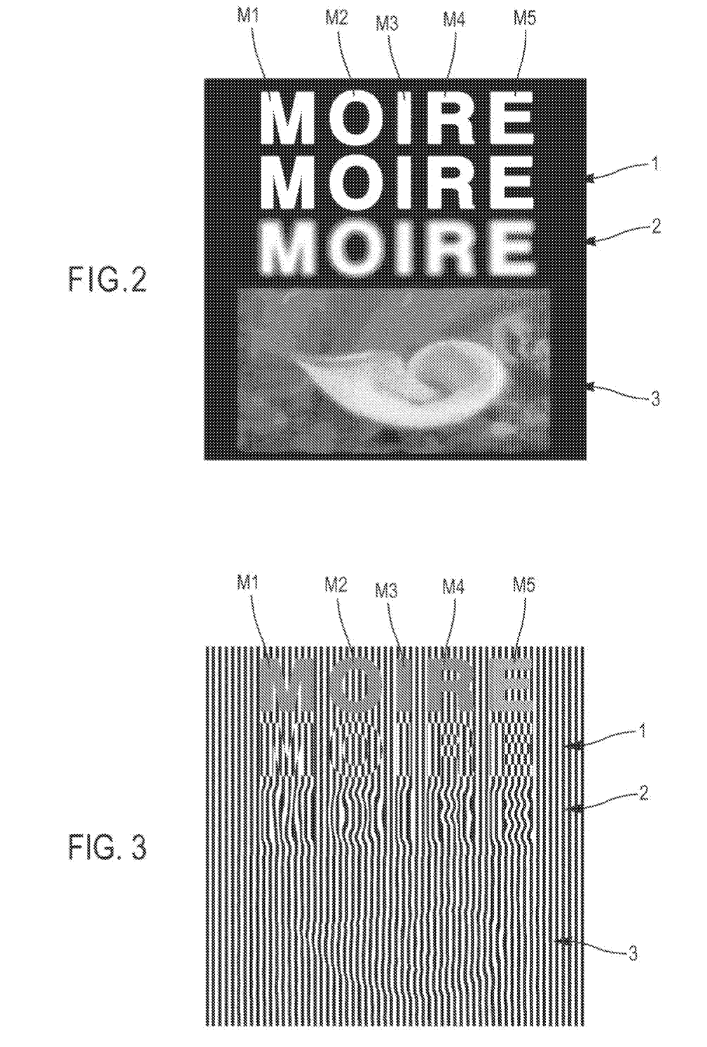

Referring to FIGS. 1A to 2, the dispersed image according to the invention is advantageously produced from a periodic image IP of given period and a reference image IR, by means of a computer program for processing the image.

The reference image IR represents, to within the colours, that which will be seen in the iridescent image. Such a reference image is for example a photograph, a pattern, a text or the like. It preferably has the same proportions as the periodic image IP.

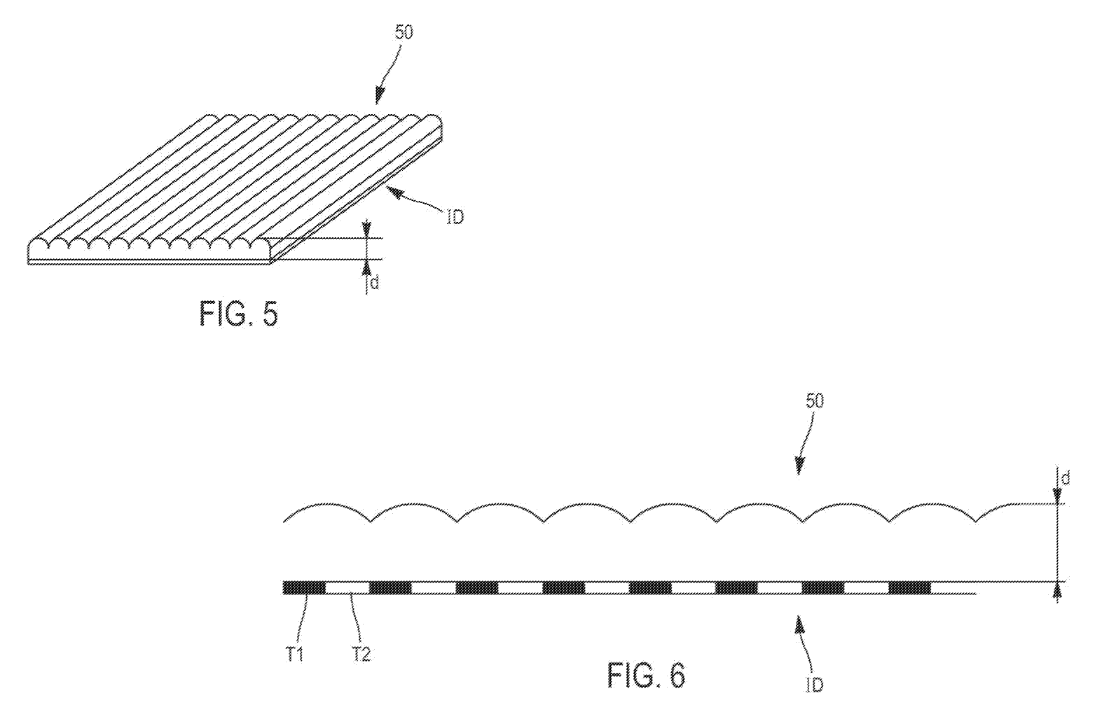

The periodic image IP used comprises a period of five black pixels T1 and five white pixels T2 illustrated in FIG. 1B. The period is chosen so as to be suited to the reproduction system that will be used and to the optical selector, consisting here of an array of linear lenses. Such an array of lenses is shown in FIGS. 5 and 6.

The periodic image IP will give its colours to the iridescent image -II-. Its colour mode is the same as that of the period and its resolution is the same as that of the period. Its size is the same as that of the iridescent image that it is wished to form. In addition, the period and the periodic image preferably have a maximum resolution with respect to the quality of the reproduction system used, so that the period has many pixels, which makes it possible to produce rich gradations, and a better defined movement of pixels when the dispersion filter is applied.

In general terms, the period defines the colours that will be perceived in the iridescence effects of the iridescent image. Interestingly, the invention is implemented without requiring a marking of the colours to be printed, and the period comprises pixels representing either a single layer, in flat tint or in grey level, or two layers the lightest of which is preferably invariant over the whole of the period.

According to another variant not shown, the invention is implemented with colour marking means, and the period comprises as many colour layers as the reproduction system permits, typically in cyan magenta yellow black for printing.

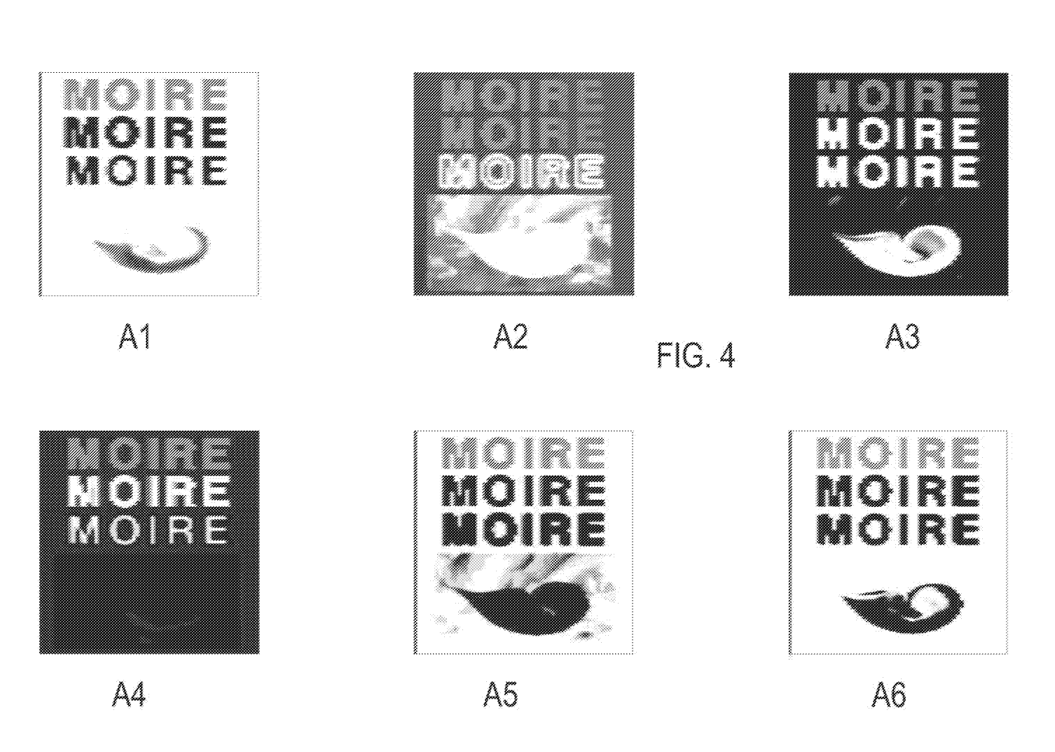

Referring to FIGS. 3 and 4, the dispersed image ID obtained comprises the pixels T1 and T2 of the periodic image that were displaced by applying a dispersion filter (displacement mapping) detailed below. The displacement is here perpendicular to the array of longitudinal lenses, and to the left. The dispersed image ID is associated with an array of cylindrical lenses SO adapted to produce an iridescent image -II-. The application of fuzziness to the reference image makes it possible to display a characteristic border be around the drawing in the iridescent image. When there is no application of fuzziness in the reference image of the same resolution as the periodic image, the dispersed image shows sharp ruptures of the periodic elements, and the iridescent image does not show a characteristic border essentially because of the absence of fuzziness in the reference image.

In addition the iridescent image II shows iridescent visual effects that are light and dark depending on the angle of observation, and the area of the image observed as illustrated in FIG. 4. It is possible to perceive the iridescence effect in FIG. 4 by observing two successive images, for example A1 and A2, stereoscopically for example in cross-vision or using a stereoscope.

The reference image IR in FIG. 2 comprises a text composed of five marks M1 to M5, a non-blurred text 1, a blurred text 2 and a photograph 3 in grey level.

According to a preferred variant, it is possible to use a mask for the application of the dispersion filter (as in FIGS. 1A, 2 and 3), the periodic image was created by filling it in with the period repetitively, using five masks for providing the non-periodic reserve areas that will not have any iridescence effect. The corresponding areas in the reference image IR will advantageously be filled in with the corresponding colour at zero displacement when the dispersion filter is applied.

According to another preferred variant, it is also possible to make use of masks for filling in the periodic image with areas of periods with different colours (not shown), before the dispersion filter is applied.

The use of a mask (not shown) may also consist of sticking elements in the dispersed image before reproduction thereof,
either in complete replacement for the area of the dispersed image,
or with an opacity value,
or using a fusion mode.

The last two uses make it possible in particular to obtain on a photograph a mixture of the original photograph and the iridescence effect.

The use of a mask (not shown) may also consist of applying a colorimetric filter to the periodic image or the dispersed image.

FIGS. 5 and 6 illustrate an example of association of an array of lenses SO and a dispersed image ID. The dispersed image ID comprises pixels T1, T2, and is intended to be for example printed on the opposite face of the array of lenses SO or laminated thereon. A spacing -d- must be provided between the array of lenses and the dispersed image according to the focal distance of the cylindrical lenses.

The production of a linear parallax barrier may comprise the steps of:
creating a period where the number of pixels and the resolution depends on the required resolution of the barrier, for example a linear barrier of 120 lpi may be produced with a period of 10 pixels in 1200 dpi according to the equation

number of pixels in the period=resolution of the period/resolution of the barrier,
filling part of the period with black pixels, for example 50% black pixels as in FIG. 1B
creating a periodic image, with the same resolution as said period and with the same size as the required parallax barrier, filled repetitively according to said period,
forming said periodic image using a transparent or translucent substrate and a suitable reproduction system making it possible to obtain opaque areas for each black pixel in said periodic image.

Thus, in a variant, before the formation, a dispersion filter may also be applied to said periodic image representing the parallax barrier in order to distribute the displacements both on the parallax barrier and on the dispersed image.

The association consists of assembling the dispersed image ID with the optical selector SO so as to obtain the iridescent image II. When the optical selector SO consists of lenses (linear or spherical) the dispersed image ID must be situated substantially at the focal distance of said lenses. In general the thickness of the arrays of lenses that are found commercially meets this requirement so that the image must be situated on the face opposite to the lenses (cf. FIGS. 5 and 6).

When the optical selector SO is a parallax barrier it is necessary to provide a distance between the barrier and the ID. To obtain an iridescence effect, that is to say so that the two eyes of the observer perceive different images, it is necessary to ensure that this distance is not too small.

### Example 1

### Array of Linear Lenses

In the case of a linear array of 120 lenses per inch and a reproduction system in 1200 dpi, the suitable period will be 1200 dpi and will comprise 10 pixels in a line, which may for example be arranged in one of the following ways:
5 black pixels and 5 white pixels;
a gradation from white to black over the 10 pixels;
a gradation from white to black from pixel 1 to pixel 5 and from black to white from pixel 6 to pixel 10.

### Example 2

### Array of Spherical Lenses

In the case of a spherical array of 120 lenses per inch and a reproduction system in 1200 dpi, the suitable period will be 1200 dpi and will be a square of 10×10 pixels, which may be arranged in the following manner:
black for the areas (1,1) to (5,5) and (6,6) to (10,10), and
white for the other areas.

In order to obtain a period with a gradation, the pixels may be arranged in the following manner:
a gradation from white to black from (1,1) to (1,10) and from (1,1) to (10,1);
a gradation from black to white from (1,10) to (10,10) and from (10,1) to (10,10);
the internal pixels from (2,2) to (9,9) being filled in by bilinear interpolation of the pixels of the contour thus defined.

Still for obtaining a period with a gradation, it is possible to create a fuzzy black circle at the centre of the square, leaving the pixels of the contour white.

The iridescent image is created by a method that comprises steps consisting of:

(1) characterising the geometric and repetitive structure of the optical selector, and optionally producing the optical selector, for example as detailed previously for a parallax barrier,

(2) creating the period the size of which (that is to say the number of pixels XY) depends on the characteristics of the optical selector and the resolution of the reproduction system used for reproducing the dispersed image,

(3) creating the periodic image IP by filling it in with the periods repetitively. Optionally use could be made of masks in order to have several areas of periods with different colours or non-periodic areas that will not have any iridescence effects, or to apply a colorimetric filter,

(4) creating the reference image IR comprising elements such as a drawing, a photograph, a text, a pattern, etc.,

(5) generating a dispersed image ID by applying a dispersion filter to the periodic image IP in order to move all the pixels thereof according to the corresponding values of pixels in the reference image, in accordance with the formula

ID=DispMap(IP,IR)

(6) Producing the iridescent image -II- by associating the dispersed image ID with the optical selector, which may consist of a direct printing on the face of the optical selector opposite to the observer, a printing followed by a sticking against this face, any other form of reproduction.

The dispersion filter (displacement mapping) requires, for each pixel (Xip, Yip) of the periodic image IP, the calculation of the coordinates (Xir, Yir) of its reference pixel in the IR.

When the periodic image IP and the reference image IR have the same size and the same resolution, that is to say the same number of pixels horizontally and vertically, the coordinates of the respective pixels are equal, in accordance with the formula:

$$\{ \begin{matrix}{X}_{MAXir} = {X}_{MAXip} ; \\ and \\ {Y}_{MAXir} = {Y}_{MAXip}\end{matrix} = > \{ \begin{matrix}Xir = Xip \\ and \\ Yir = Yip\end{matrix}$$

in which X_{MAXir}, Y_{MAXir} and X_{MAXip}, Y_{MAXip} are the respective sizes (on the x axis and y axis) of the reference IR and period IP images and the coordinates Xir, Yir, Xip, Yip are integer numbers.

Likewise, when the periodic image IP and the reference image IR are of different sizes, the coordinates of the reference pixels are calculated in accordance with the formula

$$\{ \begin{matrix}{X}_{MAXir} \neq {X}_{MAXir} ; \\ and \\ {Y}_{MAXir} \neq {Y}_{MAXip}\end{matrix} = > \{ \begin{matrix}Xir = Xip \cdot ( {X}_{MAXir} / {X}_{MAXip} ) \\ and \\ Yir = Yip \cdot ( {Y}_{MAXir} / {Y}_{MAXip} ) .\end{matrix}$$

In this case, the coordinates Xir, Yir are real numbers and the corresponding value is calculated by bilinear interpolation of the values of the adjacent full pixels.

Concerning the calculation of the displacement value, the value of a pixel in the reference image IR represents a colour such as a grey level, or three red green blue values. It is a case of making a pixel displacement value correspond to this colour. To do this, it is necessary to limit the maximum displacement (Bmax), which will preferably be between half and twice the size of a period. When the colour varies from its minimum to its maximum the value of the displacement may vary from 0 to the maximum bound defined (Bmax) or from −Bmax/2 to +Bmax/2.

The means for producing the dispersed image intended for producing the iridescent image according to the invention are preferably implemented by computer, using image processing software. The dispersed image obtained is then generated and associated with an optical selector as developed previously.

In the case of the use of a lenticular array consisting of cylindrical lenses or a parallax barrier consisting of lines, these must be vertical in order to obtain the best iridescence effect. However, it may be interesting to incline the lines or lenses by an angle alpha from 25 to 65 degrees. The iridescence effect is then always preserved and the substrate also has the advantage of coming alive when it is pivoted from bottom to top.

Two ways of proceeding can be distinguished:

The first comprises a rotation of the periodic image IP by alpha degrees, and then filling in the period, and then rotation of the reference image IR by alpha degrees, then the creation of a dispersed image ID by applying the dispersion filter creating a horizontal displacement (dx), and then associating the dispersed image ID with the optical selector SO. The image will then be looked at by returning it by minus alpha degrees.

The second way of proceeding comprises the filling-in of the periodic image IP with the period inclined by alpha degrees, and then creating the dispersed image ID by applying the dispersion filter creating a displacement (dx, dy) perpendicular to the cylindrical lenses and to the lines of the parallax barrier, before formation, and the association of the dispersed image ID with the optical selector SO, itself inclined by an angle of alpha degrees.

It should be noted that, in the case of a parallax barrier associated with a dispersed image, it is possible as required to decide to place one or other in front or behind. The formation will take account of this choice.

In another variant of the invention, it is also possible to obtain an iridescent image in the following manner. A first dispersed image is calculated, with a displacement value varying from 0− to +Bmax; then a second dispersed image is calculated with a displacement value varying from 0 to −Bmax; and these two images are associated on either side of a transparent or translucent substrate so that the dispersed image closer to the observer fulfils the role of optical selector in combination with the transparent or translucent substrate chosen in a suitable size. In the case of etching in a glass block, the image is reproduced inside the glass block, at the previously mentioned distance. In another variant of the invention implemented with a parallax barrier, it is also possible to obtain an iridescent image in the following way. A first dispersed image is calculated, preferably from the same reference image, with a displacement value varying from 0 to +Bmax; then a second dispersed image is calculated, preferably from a second periodic image adapted to said parallax barrier, with an opposite displacement value varying from 0 to −Bmax; and these two images are associated on either side of a transparent or translucent substrate so that the dispersed image closer to the observer fulfils the role of optical selector in combination with the transparent or translucent substrate chosen in a suitable size. In the case of etching in a glass block, the two dispersed images are reproduced inside the glass block, at the previously mentioned distance. Such a second periodic image adapted to a parallax barrier advantageously comprises an alternation of black pixels and white pixels.

The invention is not limited to the embodiments disclosed above. For example, numerous combinations can be envisaged without departing from the scope of the invention.

1. Method for producing an iridescent image (II) from a reference image (IR), the iridescent image (II) comprising an optical selector (SO) selected from the group comprising an array of cylindrical lenses, an array of spherical lenses and a parallax barrier, the method comprising the steps of
creating a period adapted to the optical selector (SO) and to the reproduction system used,
creating a periodic image (IP) filled in a repetitive manner according to said period,
creating a dispersed image by applying a dispersion filter to the periodic image (IP), in which the geometric position of the pixels of the periodic image (IP) is modified according to the values of the corresponding pixels in the reference image (IR),
associating the dispersed image (ID) thus created with the optical selector (SO).

2. Production method according to claim 1, characterised in that it also comprises a step of applying fuzziness to all or part of the reference image (IR) before the step of applying said dispersion filter.

3. Production method according to claim 1, characterised in that the step of creating the periodic image and/or the step of creating the dispersed image is performed by means of at least one mask covering at least part of the periodic image and/or of the dispersed image and/or of the optical selector.

4. Production method according to claim 1, characterised in that the colour mode of the period represents either a single colour layer, in bitmap or grey level, or three red green blue layers, or four cyan magenta yellow black layers, or two layers of colours the lightest of which is a constant value over the whole of said period.

5. Production method according to claim 1, characterised in that the modification of the position of the pixels has an amplitude of between half and twice the size of a period.

6. Production method according to claim 1, characterised in that the colour mode of the reference image (IR) represents either a grey-level layer, or three red green blue layers.

7. Production method according to claim 1, characterised in that the resolution of the reference image (IR) is less than or equal to the resolution of the periodic image (IP).

8. Production method according to claim 1, in which the optical selector is a parallax barrier, and a second dispersed image is created from the reference image by applying a second dispersion filter to a periodic image suited to said parallax barrier, and the step of associating the two dispersed images in order to create the iridescent image comprises a reproduction of said dispersed images on either side or in a transparent or translucent substrate so that the parallax barrier consists of one of the two dispersed images in combination with the transparent or translucent substrate.

9. Dispersed image obtained from a reference image (IR) that represents either a grey-level layer, or three red green blue layers, or four cyan magenta yellow black layers and/or over all or part of which a fuzziness is applied, and the dispersed image being intended to be observed through an optical selector (SO), characterised in that the dispersed image (ID) is formed by pixels with a modified position by application of a dispersion filter in which the geometric position of the pixels of a periodic image (IP) of given period is modified according to the values of the corresponding pixels in the reference image.

10. Iridescent image comprising a dispersed image (ID) according to claim 9, in which the reference image (IR) represents either a grey-level layer, or three red green blue layers, or four cyan magenta yellow black layers and/or over all or part of which a fuzziness is applied, the iridescent image being associated with an optical selector (SO) selected from the group comprising an array of linear lenses, an array of spherical lenses or a parallax barrier.

11. Secret image comprising an image dispersed according to claim 9, in which the reference image (IR) represents either a grey-level layer, or three red green blue layers, or four cyan magenta yellow black layers and/or over all or part of which a fuzziness is applied, the secret image being intended for one or more given observers, characterised in that the corresponding period and/or optical selector (SO) are known to and/or held solely by said one or more given observers so as to be able to recreate the corresponding iridescent image.

12. Anti-counterfeit security image comprising a dispersed image according to claim 9, in which the reference image (IR) represents either a grey-level layer, or three red green blue layers, or four cyan magenta yellow black layers and/or over all or part of which a fuzziness is applied, or an iridescent image, in which the reference image (IR) represents either a grey-level layer, or three red green blue layers, or four cyan magenta yellow black layers and/or over all or part of which a fuzziness is applied.

13. Device characterised in that it comprises an iridescent image according to claim 10, in which the reference image (IR) represents either a grey-level layer, or three red green blue layers, or four cyan magenta yellow black layers and/or over all or part of which a fuzziness is applied, the device being selected from the group comprising a bank or telephone card, a shop window, a package, a decoration, a press dossier, a greetings card, a garment or footwear marking, a ruler, a key fob, a flask, a bottle, a plate, a glass, a vase, a shade, a communication element such as a commercial card, or a publishing product such as a poster, a postcard, a bookmark, a file cover, a book, a notebook or copy book, an item of jewelry such as a bracelet, a pendant, a brooch or the face of a watch or clock, a tile or glazing.

14. Computer program product able to be loaded into the memory of a control unit such as a computer, comprising means for implementing the method according to claim 1.

15. Iridescent image comprising a dispersed image (ID) obtained by the method of claim 1, in which the reference image (IR) represents either a grey-level layer, or three red green blue layers, or four cyan magenta yellow black layers and/or over all or part of which a fuzziness is applied, the iridescent image being associated with an optical selector (SO) selected from the group comprising an array of linear lenses, an array of spherical lenses or a parallax barrier.

16. Secret image comprising an image dispersed according to the method of claim 1, in which the reference image (IR) represents either a grey-level layer, or three red green blue layers, or four cyan magenta yellow black layers and/or over all or part of which a fuzziness is applied, the secret image being intended for one or more given observers, characterised in that the corresponding period and/or optical selector (SO) are known to and/or held solely by said one or more given observers so as to be able to recreate the corresponding iridescent image.

17. Anti-counterfeit security image comprising a dispersed image obtained by the method of claim 1 in which the reference image (IR) represents either a grey-level layer, or three red green blue layers, or four cyan magenta yellow black layers and/or over all or part of which a fuzziness is applied, or an iridescent image, in which the reference image (IR) represents either a grey-level layer, or three red green blue layers, or four cyan magenta yellow black layers and/or over all or part of which a fuzziness is applied.

18. Device characterised in that it comprises an iridescent image obtained by the method of claim 1, in which the reference image (IR) represents either a grey-level layer, or three red green blue layers, or four cyan magenta yellow black layers and/or over all or part of which a fuzziness is applied, the device being selected from the group comprising a bank or telephone card, a shop window, a package, a decoration, a press dossier, a greetings card, a garment or footwear marking, a ruler, a key fob, a flask, a bottle, a plate, a glass, a vase, a shade, a communication element such as a commercial card, or a publishing product such as a poster, a postcard, a bookmark, a file cover, a book, a notebook or copy book, an item of jewelry such as a bracelet, a pendant, a brooch or the face of a watch or clock, a tile or glazing.
